(19) United States
(12) Patent Application Publication
(10) Pub. No.: US 2013/0087730 A1
(43) Pub. Date: Apr. 11, 2013

(54) VALVE DEVICE

(71) Applicants: Naohito SEKO, Obu-city (JP); Yoshiaki YAMAMOTO, Anjo-city (JP)

(72) Inventors: Naohito SEKO, Obu-city (JP); Yoshiaki YAMAMOTO, Anjo-city (JP)

(73) Assignee: DENSO CORPORATION, Kariya-city (JP)

(21) Appl. No.: 13/616,537

(22) Filed: Sep. 14, 2012

(30) Foreign Application Priority Data
Oct. 7, 2011 (JP) 2011-223074
Jul. 31, 2012 (JP) 2012-170038

(51) Int. Cl. F16K 1/00

(52) U.S. Cl. 251/318

(57) ABSTRACT

A valve device includes a shaft, a valving element, a housing, a bearing part, and a breathing path. The shaft is driven in its axial direction. The valving element is displaced integrally with the shaft. The housing accommodates the valving element. The bearing part is provided for the housing, and includes a sliding hole, in which an end portion of the shaft is inserted and which supports the shaft slidably in the axial direction, thereby limiting a displacement direction of the shaft and the valving element to the axial direction. The breathing path communicates between a bottom part of the sliding hole and an inside of the housing.

### CROSS REFERENCE TO RELATED APPLICATION

This application is based on Japanese Patent Application No. 2011-223074 filed on Oct. 7, 2011, and Japanese Patent Application No. 2012-170038 filed on Jul. 31, 2012, the disclosures of which are incorporated herein by reference.

### TECHNICAL FIELD

The present disclosure relates to a valve device in which a valving element is driven in an axial direction. For example, the present disclosure relates to a technology which is suitably used for a valve device that controls coolant (example of fluid).

### BACKGROUND

A valve device (e.g., poppet valve) that controls fluid by driving a valving element in the axial direction is known. The valving element, which is disengaged from a valve seat, is influenced by a flow of fluid. For this reason, there is a demand to increase supporting rigidity of the valving element influenced by the flow of fluid.

Accordingly, in JP-A-2005-249021, there is proposed a valve device which improves the supporting rigidity of a valving element by the following three means: (i) a shaft is provided on both sides of the valving element in its axial direction; (ii) an intermediate region of a shaft on one side of the valving element (i.e., one guide bar) is supported slidably in the axial direction; and (iii) an end portion of a shaft on the other side of the valving element (i.e., the other guide bar) is supported slidably in the axial direction.

A part that slidably supports the end portion of the shaft is constituted of (a) a shaft which is displaced integrally with the valving element, and (b) a bearing part that is provided for a valve housing and that includes a sliding hole, in which the end portion of the shaft is inserted and which supports the shaft slidably in the axial direction. As above, the end portion of the shaft is supported slidably in the axial direction by the sliding hole, so that displacement directions of the shaft and the valving element can be limited to the axial direction. As a result, the supporting rigidity of the valving element can be improved, and eventually, stable opening and closing of the valving element can be realized for a long period of time.

However, the sliding hole, in which the end portion of the shaft is inserted, is formed in a dead end. For this reason, when the shaft is displaced in a direction in which the shaft is pulled out of the bearing part, a large negative pressure is produced between the end portion of the shaft and a bottom part of the sliding hole to prevent the displacement of the shaft. Similarly, when the shaft is displaced in a direction in which the shaft is pushed into the bearing part, coolant between the end portion of the shaft and the bottom part of the sliding hole is strongly liquid-compressed to prevent the displacement of the shaft. Therefore, according to the technology described in JP-A-2005-249021, when the shaft is moved, liquid compression and liquid expansion are caused between the end portion of the shaft and the bottom part of the sliding hole, and the movement of the shaft is thereby prevented. Consequently, a response of the valving element deteriorates, and large driving force is required for a driving means for driving the valving element.

### SUMMARY

According to the present disclosure, there is provided a valve device including a shaft, a valving element, a housing, a bearing part, and a breathing path. The shaft is driven in its axial direction. The valving element is displaced integrally with the shaft. The housing accommodates the valving element. The bearing part is provided for the housing, and includes a sliding hole, in which an end portion of the shaft is inserted and which supports the shaft slidably in the axial direction, thereby limiting a displacement direction of the shaft and the valving element to the axial direction. The breathing path communicates between a bottom part of the sliding hole and an inside of the housing.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a perspective view illustrating a bearing part in accordance with a first embodiment;

FIG. 1B is a perspective view illustrating the bearing part in which a shaft is inserted according to the first embodiment;

FIG. 2A is a perspective view illustrating a bearing part in which a shaft is inserted in accordance with a second embodiment;

FIG. 2B is a sectional view illustrating the bearing part in which the shaft is inserted according to the second embodiment;

FIG. 3 is a sectional view illustrating a bearing part in which a shaft is inserted in accordance with a third embodiment;

FIG. 4 is a perspective view illustrating a bearing part in which a shaft is inserted in accordance with a fourth embodiment; and

FIG. 5 is a sectional view illustrating a coolant valve in accordance with a fifth embodiment.

### DETAILED DESCRIPTION

Embodiments (basic configuration of a valve device in the present disclosure) will be described with reference to the drawings.

A valve device includes a shaft 1, a valving element 20, a housing 23, 24, 25, a bearing part 3, and a breathing path 4. The shaft 1 is driven in its axial direction. The valving element 20 is displaced integrally with the shaft 1. The housing 23, 24, 25 accommodates the valving element 20. The bearing part 3 is provided for the housing 23, 24, 25, and includes a sliding hole 2, in which an end portion of the shaft 1 is inserted and which supports the shaft 1 slidably in the axial direction, thereby limiting a displacement direction of the shaft 1 and the valving element 20 to the axial direction. The breathing path 4 communicates between a bottom part of the sliding hole 2 and an inside of the housing 23, 24, 25.

The embodiments (configuration of a specific example of the valve device in the present disclosure) will be explained below in reference to the accompanying drawings. The following embodiments disclose a specific example, and the present disclosure is obviously not limited to the embodiments.

### First Embodiment

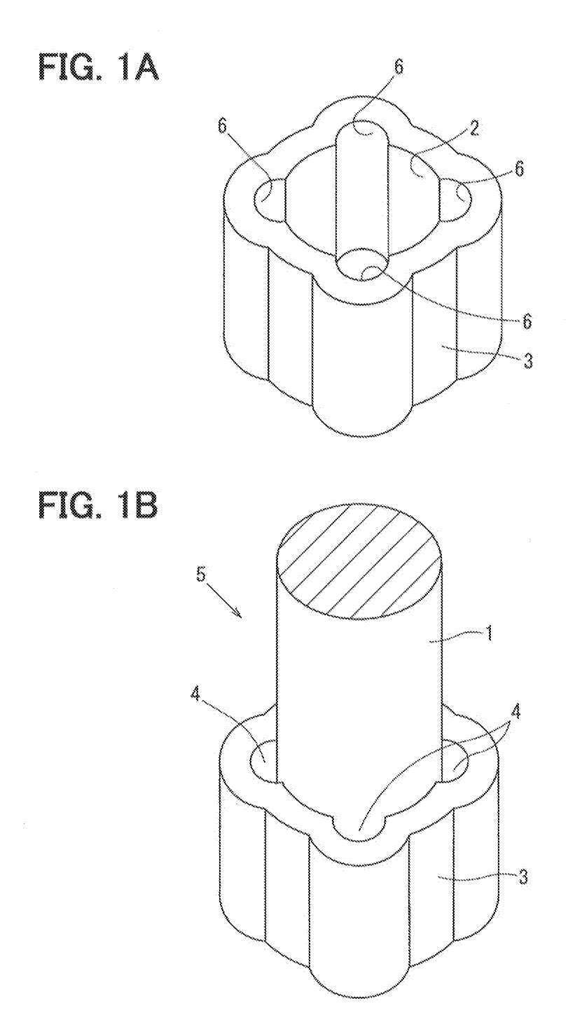

A first embodiment will be described with reference to FIGS. 1A and 1B. For the specific example of the valve device, a valve device of this embodiment is disposed in an automobile to perform flow control of engine coolant (control of opening and closing of a passage and an opening degree of the passage) or distribution control of engine coolant (control of switching of the passage).

In this valve device, a valving element is driven in an axial direction so as to perform the flow control or distribution control of engine coolant. The valve device includes the shaft 1 driven in the axial direction, the valving element 20 provided for the shaft 1, the housings 23, 24, 25 (fixing member) that accommodate this valving element 20, an intermediate bearing unit 27 that supports an intermediate part of the shaft 1 slidably in the axial direction, and a tip bearing unit 5 that supports an end portion of the shaft 1 slidably in the axial direction.

A concrete example of the tip bearing unit 5 that slidably supports the end portion of the shaft 1 will be described in reference to FIG. 1B. As described above, the tip bearing unit 5 supports the end portion of the shaft 1 slidably in the axial direction. The unit 5 includes the shaft 1 which is displaced integrally with the valving element 20, and the bearing part 3 that supports the end portion of the shaft 1 slidably in the axial direction.

The shaft 1 is made of metal having a cylindrical rod shape. The shaft 1 is fixed to the shaft center of the valving element 20 to be displaced integrally with the valving element 20. The bearing part 3 is a resin compact that is formed integrally with the housing 25 made of resin. The end portion of the shaft 1 (part of the shaft 1 including its end) is inserted in the bearing part 3. The sliding hole 2 that supports the shaft 1 slidably in the axial direction is provided for the bearing part 3.

The breathing path 4 that communicates between a bottom part of the sliding hole 2 and the inside of the housing 25 is provided for the valve device. The breathing path 4 of this first embodiment is configured by a groove 6 that is formed on an inner peripheral wall of the sliding hole 2 to extend in the axial direction as illustrated in FIG. 1A. Therefore, the breathing path 4 is defined between the shaft 1 inserted in the sliding hole 2 and the groove 6. Specifically, the groove 6 which constitutes the breathing path 4 is a streaky recess from an open end to the bottom part of the sliding hole 2. In FIGS. 1A and 1B, although it is illustrated that the four grooves 6 are formed on the inner peripheral wall of the sliding hole 2, the number of the grooves 6 is not limited to four, and one or more grooves 6 may be provided.

A first effect of the first embodiment will be described. In the valve device of this first embodiment, as described above, the shaft 1 on both sides of the valving element 20 is supported by the intermediate bearing unit 27 and the tip bearing unit 5, and supporting rigidity of the valving element 20 can thereby be improved. Specifically, in this embodiment, the bearing part 3 having the sliding hole 2 is provided for the housings 25 which accommodate the valving element 20, and the end portion of the shaft 1 is supported slidably in the axial direction by this sliding hole 2. Accordingly, as compared with a valve device that supports a shaft only by an intermediate bearing unit, the supporting rigidity of the valving element 20 can be stably improved for a long period of time, and reliability of the valve device can be increased.

A second effect of the first embodiment will be described. In the valve device of this first embodiment, as described above, the breathing path 4 that communicates between the bottom part of the sliding hole 2 and the inside of the housing 25 is provided by forming the groove 6 extending in the axial direction on the inner peripheral wall of the sliding hole 2. Accordingly, when the shaft 1 is displaced in a direction in which the shaft 1 is pulled out of the bearing part 3, the coolant flows smoothly in between the end portion of the shaft 1 and the bottom part of the sliding hole 2 through the breathing path 4. Thus, the shaft 1 can be moved smoothly. Similarly, when the shaft 1 is displaced in a direction in which the shaft 1 is pushed into the bearing part 3, the coolant between the end portion of the shaft 1 and the bottom part of the sliding hole 2 is discharged smoothly into the housing 25 through the breathing path 4. Thus, the shaft 1 can be moved smoothly.

As described above, in the valve device of this first embodiment, liquid compression and liquid expansion caused between the end portion of the shaft 1 and the bottom part of the sliding hole 2 can be avoided owing to the breathing path 4. As a result, the valving element 20 and the shaft 1 can be displaced at a low load. Accordingly, responsivity in opening and closing of the valving element 20 can be improved, and a driving load of a driving means (e.g., electric actuator) for driving the valving element 20 can be reduced.

### Second Embodiment

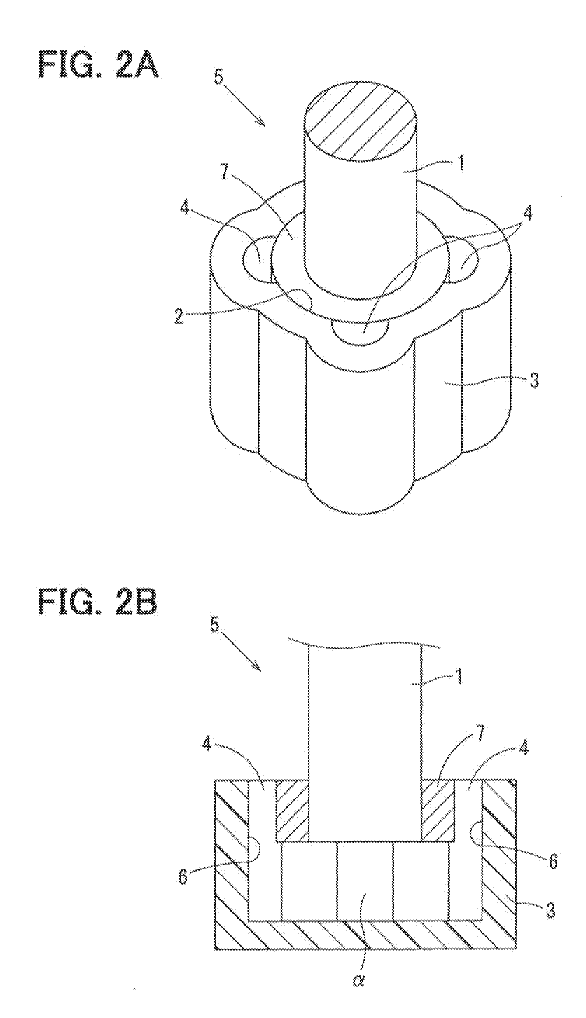

A second embodiment will be described with reference to FIGS. 2A and 2B. In the above first embodiment, it is illustrated that the shaft 1 is supported directly by the bearing part 3 made of resin. In this second embodiment, a metal slide bearing (metal bush) 7 that slidably supports a shaft 1 is provided for a bearing part 3. Accordingly, the metal shaft 1 is supported by the metal slide bearing 7, and a wear of the shaft 1 due to its sliding movement can thereby be limited for a long period of time. Therefore, supporting rigidity of a valving element 20 can be more stably improved for a long period of time. Moreover, because the metal shaft 1 is supported by the metal slide bearing 7, sliding resistance of the shaft 1 can be stably limited to be small for a long period of time.

In a valve device of this second embodiment, as illustrated in FIG. 2B, an end portion of the shaft 1 and a bottom part of a sliding hole 2 are spaced away from each other in the axial direction with the shaft 1 inserted the deepest in in the bearing part 3. As a result, a space α is defined between the end portion of the shaft 1 and the bottom part of the sliding hole 2. Accordingly, close attachment between an end surface of the shaft 1 and a bottom face of the sliding hole 2 can be prevented with the shaft 1 inserted the deepest into the bearing part 3. For this reason, a defect that prevents the displacement of the shaft 1 (defect that deteriorates a response of the valving element 20) due to this close attachment can be avoided, and a defect that increases a driving load of the shaft 1 because of the close attachment can be avoided.

### Third Embodiment

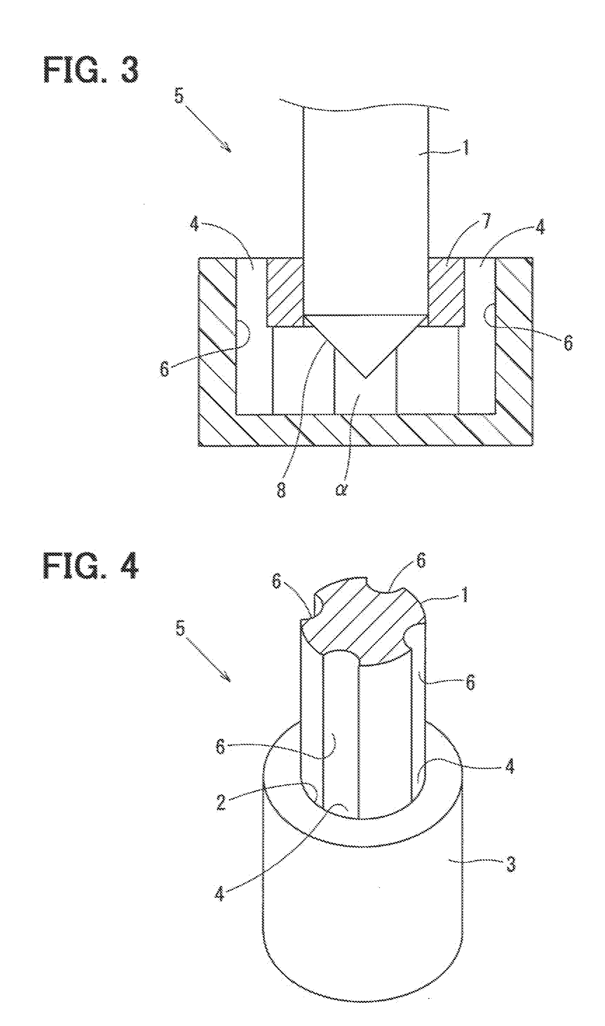

A third embodiment will be described with reference to FIG. 3. In a valve device of this third embodiment, a tapered surface 8 whose diameter is reduced toward the center of an end portion of the shaft 1 (lower side in FIG. 3) is provided on an end of a shaft 1. By forming the tapered surface 8 in this manner, when the end of the shaft 1 is brought close to a bottom part of a sliding hole 2, the tapered surface 8 pushes away the coolant. Accordingly, a driving load of a valving element 20 and the shaft 1 can be made even smaller.

### Fourth Embodiment

A fourth embodiment will be described with reference to FIG. 4. In the above first embodiment, as an example of a means for providing the breathing path 4, it is illustrated that the groove 6 is provided on the inner peripheral wall of the sliding hole 2. In this fourth embodiment, as a means for providing a breathing path 4, a groove 6 extending in the axial direction is formed on an outer peripheral wall of a shaft 1. Therefore, the breathing path 4 is defined between an inner peripheral wall of a sliding hole 2 and the groove 6 of the shaft 1. In FIG. 4, it is illustrated that the four grooves 6 are provided on the outer peripheral wall of the shaft 1. However, the number of the grooves 6 is not limited to four, and one or more grooves 6 may be provided. By this configuration as well, an effect similar to the above first embodiment can be produced.

### Fifth Embodiment

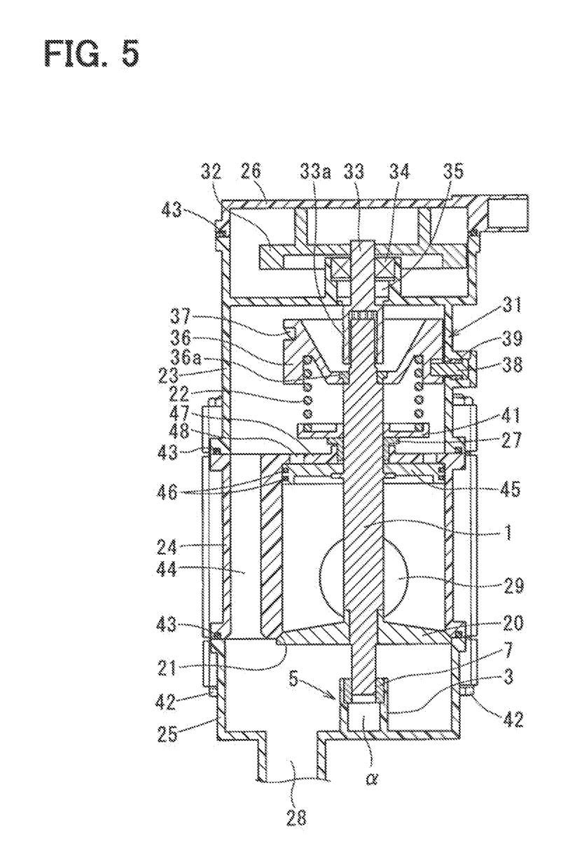

A fifth embodiment will be described with reference to FIG. 5. In the following description, an upper side in FIG. 5 is referred to as “up”, and a lower side in FIG. 5 as “down”. However, these up-down directions are only directions for explaining the embodiment, and they are not related to a mounting direction of a valve device on a vehicle.

The valve device illustrated in FIG. 5 is a coolant valve (two-way valve) that performs flow control of engine coolant (control of opening and closing of a passage and a flow rate). Although a coolant valve having a two-way valve structure is described below as a specific example, the device is not limited to this. The present disclosure may be applied to a coolant valve (e.g., three-way valve) that performs distribution control of coolant (control of switching of distribution of passages and a distribution flow rate).

This valve device includes a shaft 1 driven in its axial direction, a valving element 20 fixed to a halfway portion (lower side) of this shaft 1 in the axial direction, a driving means for driving the shaft 1 in the axial direction, a spring 22 that presses the valving element 20 on a valve seat 21 when the valve device is fully closed, a housing provided by combining together an upper housing 23, a middle housing 24, a lower housing 25, and a cover 26, an intermediate bearing unit 27 that supports an intermediate part of the shaft 1 slidably in the axial direction, and a tip bearing unit 5 that supports a lower end of the shaft 1 slidably in the axial direction.

The valving element 20 is displaced upwards to be engaged with the valve seat 21, and a communication between an input port 28 and an output port 29 is thereby closed. The valving element 20 is displaced downwards to be disengaged from the valve seat 21, and the input port 28 and the output port 29 thereby communicate with each other. In accordance with increase of the amount of disengagement of the valving element 20 from the valve seat 21 (descending amount of the valving element 20), a degree of communication between the input port 28 and the output port 29 becomes greater.

The valve device of this embodiment will be described in detail below. The shaft 1 has a shape of a generally cylindrical rod extending in the up-down directions. The shaft 1 is supported slidably in the up-down directions by the intermediate bearing unit 27 and the tip bearing unit 5, which have been described above.

The valving element 20 is a poppet valve having an umbrella shape (generally disc shape) whose diameter is increased radially outward from the outer periphery of the shaft 1. The central portion of this valving element 20 is fixed to the shaft 1, and the valving element 20 is moved in the up-down directions integrally with the shaft 1.

The driving means decelerates (torque increased) torque generated by an electric motor and then converts the rotation into the axial movement to drive the shaft 1. The driving means includes an electric motor (e.g., DC motor: not shown) that can switch between rotations in both forward and reverse directions, a gear reducer which transmits the torque of this electric motor to the shaft 1, and a converting unit 31 that converts the torque transmitted to the shaft 1, into the movement of the shaft 1 in its axial direction.

The gear reducer is arranged in an accommodating space for a gear train provided between the cover 26 and the upper housing 23. A gear shaft 33, to which a final gear 32 of the gear reducer is fixed, is rotatably supported by the upper housing 23 through a bearing (e.g., ball bearing) 34. A numeral 35 located directly below the bearing 34 is a sealing member. The sealing member is provided so that the coolant supplied to an accommodating space of a cam plate 36 which is described in greater detail hereinafter cannot leak into the accommodating space of the gear train.

A cylindrical body 33a for a joint, into which the shaft 1 is inserted, is provided on a lower side of the gear shaft 33. The inner periphery of the cylindrical body 33a, and the outer periphery of an upper end of the shaft 1 inserted in this cylindrical body 33a are fitted together through spline grooves which are along the axial direction. As a result of this configuration (spline fitting in the axial direction), the rotary torque of the gear shaft 33 is transmitted to the shaft 1, and the shaft 1 is provided to be movable in the axial direction relative to the gear shaft 33.

The converting unit 31 includes the cam plate (rotary cam) 36 rotated integrally with the shaft 1, and a pin 38 fitted into a cam groove 37 formed on an outer peripheral wall surface of this cam plate 36.

The cam plate 36 is coupled firmly with the shaft 1 through a coupling member 36a, and includes a cylindrical outer peripheral wall surface on its outer diameter side. The cam groove 37 is one groove extending continuously in a circumferential direction of the plate 36 on the outer peripheral wall surface of the cam plate 36. An axial position of the cam groove 37 change smoothly in in accordance with an angle of the cam plate 36 in its circumferential direction (rotation direction). An end (side closer to the shaft 1) of the pin 38 is constantly fitted into the cam groove 37. An outer side (side away from the shaft 1) of the pin 38 is rotatably supported by the upper housing 23 via a bearing 39.

The spring 22 is a compression spring that urges the shaft 1 upwards through the cam plate 36. The spring 22 is compressed and arranged between a spring seat 41 that is rotatably supported on an upper surface of the intermediate bearing unit 27 (e.g., slide bearing), and the cam plate 36.

The upper housing 23, the middle housing 24, the lower housing 25 are stacked in the axial direction (up-down directions), and in this embodiment, they are coupled together by a stud bolt 42. A packing (O-ring) 43 is disposed respectively between the upper housing 23 and the middle housings 24 and between the middle housing 24 and the lower housings 25. The packing 43 is provided so that coolant inside the valve device does not leak to the outside.

The input port 28, to which coolant is supplied, is provided for the lower housing 25. The coolant, which is supplied from the input port 28, is supplied into the accommodating space of the cam plate 36 (internal space of the upper housing 23) through a bypass passage 44.

The valve seat 21, with which the valving element 20 is engaged at the time of closing of the valve device, is formed at a lower part of the middle housing 24. The output port 29 for coolant is provided at a lower part of a cylindrical portion provided on an upper side of the valve seat 21 and inside the middle housing 24 (i.e., sliding wall of a partition plate 45 described in greater detail hereinafter).

The partition plate (piston) 45 having a disc shape that liquid-tightly divides the inside of the cylindrical portion in the up-down directions is fixed to the intermediate part of the shaft 1 (upper side of the valving element 20). Similar to the valving element 20, the partition plate 45 is displaced in the up-down directions integrally with the shaft 1. A numeral 46 arranged in an annular groove on the outer periphery of the partition plate 45 is a seal ring (O-ring). The seal ring 46 is for sealing a sliding clearance between the partition plate 45 and an inner peripheral wall of the middle housing 24.

Supply pressure of the coolant supplied upwards through the bypass passage 44 is applied to the upper surface of this partition plate 45. Specifically, the supply pressure of the coolant guided around the cam plate 36 through the bypass passage 44 is supplied onto the upper surface of the partition plate 45 through a through hole 48 in up-down directions which is provided for a supporting wall 47 which supports the intermediate bearing unit 27.

Accordingly, in a state in which the valving element 20 is engaged with the valve seat 21 (when the valve device is fully closed), a force with which the supply pressure of coolant pushes up the valving element 20 can be canceled out by a force with which the supply pressure of coolant pushes down the partition plate 45. Accordingly, valve opening force when opening the valving element 20 from a valve-closing state (force generated by the electric motor at the valve-opening time) can be made small.

In addition, materials (e.g., metallic material or resin material) in accordance with respective members are appropriately selected and used for the above-described members, and the material of each member is not limited. Any one of the first to fourth embodiments of the present disclosure is applied to the tip bearing unit 5, and an effect according to the applied embodiment can be produced.

Industrial applicability of the valve device will be described below.

The above embodiments may be combined together to be used for the valve device.

In the above embodiments, it is illustrated that the breathing path 4 is provided by forming the groove 6 on the inner peripheral wall of the sliding hole 2 or the outer peripheral wall of the shaft 1. Alternatively, the breathing path 4 may be formed in any mode as long as it communicates between the bottom part of the sliding hole 2 and the inside of the housing 25. The breathing path 4 may be provided by, for example, a through hole passing through the inside and outside of the bearing part 3 (i.e., the bottom part of the sliding hole 2 and the outer wall of the bearing part 3).

In the above embodiments, it is illustrated that the passage area of the breathing path 4 is made large (i.e., the cross-sectional area of the groove 6 is made large, and more than one groove 6 are employed) to make the movement resistance of the shaft 1 as small as possible. Alternatively, the passage area of the breathing path 4 may be deliberately made small to control the movement speed of the shaft 1. Accordingly, the movement speed of the valving element 20 can be controlled.

In the above embodiments, it is illustrated that the bearing part 3 is formed integrally with the housing 25. Alternatively, the bearing part 3 which is provided separately may be attached to the housing 25.

In the above embodiments, it is illustrated that the present disclosure is applied to the valve device which controls engine coolant. Alternatively, the present disclosure may be applied to a valve device which controls circulating water for exhaust heat recovery in a vehicle without an engine, as well as the engine coolant.

In the above embodiments, it is illustrated that the present disclosure is applied to the valve device which controls liquid (coolant as a specific example). Alternatively, fluid is not limited to the liquid. The present disclosure may be applied to a valve device which controls gas.

To sum up, the valve device of the above embodiments can be described as follows.

According to the valve device of the first aspect, the bearing part 3 having the sliding hole 2 is provided for the valve housings 23, 24, 25 which accommodate the valving element 20, and the end portion of the shaft 1 is supported slidably in the axial direction by this sliding hole 2. Accordingly, the supporting rigidity of the valving element 20 can be stably improved for a long period of time, and reliability of the valve device can be increased. Moreover, the valve device of the first aspect includes the breathing path 4 that communicates between the bottom part of the sliding hole 2 and the inside of the valve housings 23, 24, 25. Owing to this breathing path 4, fluid compression and fluid expansion caused between the end portion of the shaft 1 and the bottom part of the sliding hole 2 can be avoided. The valving element 20 and the shaft 1 can be displaced at a low load. Therefore, responsivity in opening and closing of the valving element 20 can be improved, and a driving load for the driving means for driving the valving element 20 can be reduced.

The breathing path 4 of the second aspect may be configured as a groove 6 that is formed on an inner peripheral wall of the bearing part 3 which defines the sliding hole 2. The groove 6 extends in the axial direction. Accordingly, by providing the groove 6 on the inner peripheral wall of the sliding hole 2, the effect of the above first aspect can be produced.

The breathing path 4 of the third aspect may be configured as a groove 6 that is formed on an outer peripheral wall of the shaft 1 and that extends in the axial direction. Accordingly, by providing the groove 6 on the outer peripheral wall of the shaft 1, the effect of the above first aspect can be produced.

According to the valve device of the fourth aspect, a space a may be defined between the end portion of the shaft 1 and the bottom part of the sliding hole 2 with the shaft 1 inserted the deepest in the bearing part 3. Accordingly, a defect such as hindrance to the movement of the shaft 1 due to the close attachment between the end surface of the shaft 1 and the bottom face of the sliding hole 2 can be avoided, and a defect that increases a driving load of the shaft 1 because of the close attachment can be avoided.

The bearing part 3 of the fifth aspect may further include a metal slide bearing 7 that slidably supports the shaft 1. Accordingly, a wear of the shaft 1 due to its sliding movement can be limited for a long period of time. Therefore, supporting rigidity of a valving element 20 can be more stably improved for a long period of time.

The end portion of the shaft 1 of the sixth aspect may include a tapered surface 8. Accordingly, when the end of the shaft 1 is brought close to the bottom part of the sliding hole 2, the tapered surface 8 pushes away the fluid. As a result, the valving element 20 and the shaft 1 can be displaced at an even lower load.

According to the valve device of the seventh aspect, a displacement speed of the shaft 1 may be controlled by a passage area of the breathing path 4. Accordingly, the movement speed of the valving element 20 is controllable.

The valve device of the eighth aspect is a coolant valve that performs, for example, opening and closing of a coolant passage, switching or distribution of coolant passages, or adjustment of an opening degree of a coolant passage. Accordingly, the coolant valve can produce effects of one or more of the above first to seventh aspects.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A valve device comprising:
a shaft that is driven in its axial direction;
a valving element that is displaced integrally with the shaft;
a housing that accommodates the valving element;
a bearing part that is provided for the housing and includes a sliding hole, in which an end portion of the shaft is inserted and which supports the shaft slidably in the axial direction, thereby limiting a displacement direction of the shaft and the valving element to the axial direction; and
a breathing path that communicates between a bottom part of the sliding hole and an inside of the housing.

2. The valve device according to claim 1, wherein the breathing path is configured as a groove that is formed on an inner peripheral wall of the bearing part which defines the sliding hole, the groove extending in the axial direction.

3. The valve device according to claim 1, wherein the breathing path is configured as a groove that is formed on an outer peripheral wall of the shaft and that extends in the axial direction.

4. The valve device according to claim 1, wherein a space is defined between the end portion of the shaft and the bottom part of the sliding hole with the shaft inserted the deepest in the bearing part.

5. The valve device according to claim 1, wherein the bearing part further includes a metal slide bearing that slidably supports the shaft.

6. The valve device according to claim 1, wherein the end portion of the shaft includes a tapered surface.

7. The valve device according to claim 1, wherein a displacement speed of the shaft is controlled by a passage area of the breathing path.

8. The valve device according to claim 1, wherein the valve device is disposed in an automobile to perform flow control or distribution control of engine coolant.
